(19) United States
(12) Patent Application Publication
(10) Pub. No.: US 2012/0064208 A1
(43) Pub. Date: Mar. 15, 2012

(54) AZEOTROPIC POST-HARVEST FUMIGATION COMPOSITIONS OF METHYL IODIDE

(75) Inventors: Andrew Joseph Poss, Kenmore, NY (US); Rajiv Ratna Singh, Getzville, NY (US); Bjorn Hofman, Morris Plains, NJ (US); David Nalewajek, West Seneca, NY (US); Cheryl Cantlon, Clarence Center, NY (US)

(73) Assignee: Honeywell International Inc., Morristown, NJ (US)

(21) Appl. No.: 12/880,314

(22) Filed: Sep. 13, 2010

(51) Int. Cl. A23L 3/3409; A23B 4/16; A23B 7/144

(52) U.S. Cl. 426/318

(57) ABSTRACT

The present technology relates to fumigant compositions and fumigation processes, and particularly to processes for the fumigation of perishable products. The fumigant compositions comprise an azeotropic and azeotrope-like composition of methyl iodide and at least one fluorocarbon or hydrofluorocarbon. The fumigation methods include providing a fumigant composition and applying the fumigant composition to a perishable product.

### FIELD OF THE INVENTION

The present technology relates to fumigation processes, and particularly to processes for product fumigation of perishable products, which can be used in applications such as post-harvest quarantine, pre-shipment fumigation and quarantine fumigation. The fumigation processes of the present technology employ fumigant compositions having similar properties to methyl bromide, without its ozone-depleting properties. The fumigant compositions comprise an azeotropic and azeotrope-like compositions of methyl iodide and at least one fluorocarbon or hydrofluorocarbon.

### DESCRIPTION OF RELATED ART

Methyl bromide (CH₃Br) is the most widely used and most universal fumigant in the world. It is a gaseous fumigant that has been used commercially since the early 1900's and is known for being extremely effective as a herbicide, nematocide, insecticide and fungicide. It is used to control insects as a space fumigant in flour and feed mills and ship holds, as a product fumigant for some fruit and cereals, and for general quarantine purposes. Methyl bromide acts rapidly, controlling insects in less than 48 hours in space fumigations, and it has a wide spectrum of activity, controlling not only insects but also nematodes and plant-pathogenic microbes. This chemical is the primary fumigant used internationally for phytosanitary treatments. It has been requested by importers, even in the absence of a regulatory requirement, in order to ensure marketability of the product. Methyl bromide has been widely used for soil fumigation, not only for controlling a variety of pests on numerous crops, but also as a commodity quarantine treatment for imports and exports, and as a structural fumigant applied to a building, surface or the like. However, it is a Restricted Use Pesticide (RUP) because of its high acute toxicity to applicators. Methyl bromide has also been designated as an ozone-depleter, and thus its production and use have been severely restricted pursuant to the Montreal Protocol. In 1992, methyl bromide was implicated, as an ozone-depleting compound and subsequently the production levels of methyl bromide were frozen at the 1991 production levels. Methyl bromide was targeted for a 5-year phase out by the year 2005 in accordance with the Montreal Protocol. In 2006, 30 million pounds of methyl bromide was allocated for critical uses. The large volume of critical use exemptions is due to the fact that there is either no registered, or suitable replacement for methyl bromide.

An ideal fumigant should be toxic to insects, psocids, mites, nematodes, bacteria, fungi and their spores, viruses and moulds and other pest biota. It should be effective in low concentrations and should ideally have a low absorption by materials in the fumigated region. It should have a low phytotoxicity to commodities and leave either no residue or an inert residue. In addition, the ideal fumigant should present no difficulties as far as safe handling and it should no adversely affect the commodity or space that is being fumigated. All the current methyl bromide alternatives: phosphine, sulfuryl fluoride, carbonyl sulfide, carbon dioxide, and ethyl formate, fail as post-harvest fumigants for various reasons. Phosphine is widely used as a fumigant for insect control for most durable commodities, however it is less than ideal because of its very slow activity, rapid increase in insect resistance. The chemical is also flammable and corrodes various metals. Modified atmospheres with elevated carbon dioxide or lowered oxygen are effective in controlling insect populations in durable commodities. This method also acts very slowly and requires a fairly air-tight storage structure. Sulfuryl fluoride is widely used for termite control in structures and lumber but is finding, limited use with commodities because of its high fluoride residue and large dose requirements to kill insect eggs. When carbonyl sulfide is used in fumigation, there are issues with its strong rotten egg, odor. Ethyl formate, is explosive, flammable and corrosive to metal.

Efforts have been made to develop alternatives or replacements for methyl bromide as a fumigant. There currently exist only a few conventional methyl bromide alternatives, such as chloropicrin, 1,3-dichloropropene, metham sodium, and methyl iodide. Two or more of these materials are commonly applied as a mixture, to produce a product similar to methyl bromide. However, none of these potential alternatives are an adequate “drop-in replacement” for methyl bromide, based on their physical handling requirements; performance, or economics.

The term “drop-in replacement” used when the methodology, equipment, production system, and the like, of an original material do not have to be changed significantly when using a replacement material, and that a comparable amount of the replacement material can be used for the same targets as the original material. One compound that stands out from the group of methyl bromide alternatives is methyl iodide. Lindergren (J. Edon. Entomol. 31, 320, 1938) first showed. Methyl iodide was efficacious against several insect species without apparent injury to plants. Toxicity to grain weevils (Hassall, Ann appl. Biol 43, 615 1955) and other stored product insects has also been reported (Indian J. Ent 49, 363, 1987). Methyl iodide was found to be highly toxic to insects commonly found infesting processed and packaged food products (J. Stored Prod. Res., 1974, 10, 65-66). Later, in pre-plant application, methyl iodide was found effective in controlling certain plant diseases (Ohr, Plant Dis. 80, 731-731, 1996). Under post-harvest conditions, methyl iodide was non-injurious to a number of fresh fruit commodities at a low application rate, but at high rates, severe injuries were observed (Claypool and Vines, Hilgardia 24, 297, 1956). Aung (Ann. Appl. Biol. 139, 93, 2001) demonstrated that a methyl iodide dosage of 26 g/m3 for 2 h is efficacious for California red scale (Aonidiella aurantii). He also used methyl, iodide at low-to-mid application rates on late-season-coastal lemons for disinfesting California red scale on lemons, but the fruit sustained unacceptable surface rind injury. However when methyl iodide fumigation of lemon fruit was immediately followed by a forced aeration for 24 hours, fruit phytotoxicity was greatly reduced. It was concluded that the forced aeration rapidly desorbed or removed the toxic fumigant in the vicinity of the fruit and reduced the contact time of the flavedo tissues with the fumigant. (Aung Postharvest Biology and Technology 33 (2004) 45). In Aung's study of glutathione concentrations and phytotoxicity after fumigation of lemons with methyl iodide, he demonstrated that aeration at increased temperatures led to less fruit injury than room temperature treatments. He indicated that this “observation suggests that the increased temperature during aeration allows the loss, of substantial unreacted methyl iodide, which may be responsible for rapidly developing injury. This injury may be the result of numerous reactions that methyl iodide may undergo and removal of the methyl iodide prevents these reactions (Aung, Postharvest Biology and Technology 45, 2007, 141-146).

A great deal of research has been conducted in evaluating methyl iodide as a drop-in replacement for methyl bromide. Methyl iodide has been found to be equal to or better than methyl bromide in combating weeds, nematodes, and soil pathogens. Further, methyl iodide is not associated with ozone depletion, and does not result in plant toxicity when used in effective concentrations. The estimated lifetime of methyl iodide in the troposphere is between about 4 to days because it degrades rapidly via photolysis, as compared to methyl bromide with an estimated atmospheric lifetime of 1.5 years. (S. Solomon J. Geophys. Res. 99:20491-99). Methyl iodide has not been intimated in stratospheric ozone depletion. (Rassmussen, R. J. Geophys. Res., 87(C4) (1982) 3086-3090). With respect to ozone depleting potential, trichlorofluoromethane, CFC-11, is generally used as the reference gas and an ODP of 1. Methyl bromide has an ozone depleting potential (ODP) of 0.36, and methyl iodide has an ODP of 0.0015.

However, methyl iodide is a low boiling liquid, having a boiling point of 42.5° C. (108° F.), while methyl bromide has a boiling point of 3.6° C. (38° F.) and is thus a gas at ambient temperature and pressure. Methyl iodide has a vapor pressure of 25% that of methyl bromide and a higher density than methyl bromide, and hence is less volatile. Due to these differences in properties, the use of methyl iodide in existing methyl bromide equipment suffers several shortcomings such as clogged tubing, material remnants in system pipes, and long line purging processes for cleaning. Furthermore, the use of methyl iodide results in problems such as missed bed applications, since the methyl bromide equipment is designed for gaseous fumigant applications. Such missed bed applications may lead to significant crop loss in soil fumigation. Thus, while methyl iodide may serve, well as a fumigant, it is not a suitable drop-in replacement for methyl bromide.

### SUMMARY OF THE INVENTION

The present technology relates to compositions azeotropic and azeotrope-like compositions of methyl iodide and at least one fluorocarbon or hydrofluorocarbon, and to methods of using such compositions for fumigating perishable products.

In one aspect, a method of fumigating a perishable product is provided that includes providing a fumigant composition that is a gas at temperatures of about 30° C. or below, and applying the fumigant composition as a gas to a perishable product to produce a fumigated product. The fumigant composition comprising an azeotropic or azeotrope-like composition that includes a mixture of methyl iodide and at least, one fluorocarbon or hydrofluorocarbon.

In another aspect, a method of fumigating a perishable product is provided that includes providing a fumigant composition and applying the fumigant composition as a gas at a temperature from about 0° C. to about 5.0° C. to a perishable product to produce a fumigated product. The fumigant composition has a density of from about 1.5 g/cc to about 2.4 g/cc. The fumigant composition comprises an azeotropic or azeotrope-like composition that includes a mixture of methyl iodide and at least, one fluorocarbon or hydrofluorocarbon, wherein the at least one fluorocarbon or hydrofluorocarbon has an average Ozone Depletion Potential of about 0.05 or less, and a 100-year Global Warming Potential of about 1,000 or less.

### BRIEF DESCRIPTION OF THE DRAWINGS

Specific examples have been chosen for purposes of illustration and description, and are shown in the accompanying drawings, forming a part of the specification.

FIG. 1 shows a vapor pressure versus temperature curve of the methyl iodide/HFC-245fa azeotrope.

### DETAILED DESCRIPTION

The invention relates to a fumigant composition and fumigation methods that include applying a fumigant composition to a perishable product such as a harvested agricultural product. The fumigant comprises an azeotropic or azeotrope-like composition that includes a mixture of methyl iodide and at least one fluorocarbon or hydro fluorocarbon. Preferably the fumigant composition is a gas at temperatures of about 30° C. or below. In some examples, the fumigant compositions of the present technology can be sued as a fumigant alternative to methyl bromide, and can also serve as a drop-in replacement, thereby allowing for the use existing methyl bromide equipment and systems.

As used herein, the term “azeotrope-like” is intended in its broad sense to include both compositions that are strictly azeotropic and compositions that behave like azeotropic mixtures. From fundamental principles, the thermodynamic state of a fluid is defined by pressure, temperature, liquid composition, and vapor composition. An azeotropic mixture is a system of two or more components in which the liquid composition and vapor composition are equal at the stated pressure and temperature. In practice, this, means that the components of an azeotropic mixture are constant boiling and cannot be separated during distillation.

Azeotrope-like compositions are constant boiling or essentially constant boiling. In other words, for azeotrope like compositions, the composition a the vapor formed during boiling or evaporation (under substantially isobaric conditions) is identical, or substantially identical, to the original liquid composition. Thus, with boiling or evaporation, the liquid composition changes, if at all, only to a minimal or negligible extent. This is to be contrasted with non-azeotrope-like compositions, in which, during boiling or evaporation, the liquid composition changes to a substantial degree. All azeotrope-like compositions of the invention within the indicated ranges as well as certain compositions outside these, ranges are azeotrope-like.

It is well known, that at differing pressures, the composition of a given azeotrope will vary at least slightly, as does the boiling point of the composition. Thus, an azeotrope of A and B represents a unique type of relationship, but with a variable composition depending on temperature and/or pressure. It follows that, for azeotrope-like compositions, there is a range of compositions containing these components in varying proportions that are azeotrope-like. All such, compositions are intended to be covered by the term azeotrope-like as used herein.

Methyl iodide, also known as iodomethane, which is commonly abbreviated as “MeI” and has the formula CH₃I. Methyl iodide has a boiling point of about 42.5° C. and a density of about 2.3 g/cc.

At least one fluorocarbon or hydrofluorocarbon can be selected in forming a fumigant composition of the present technology such that the at least one fluorocarbon or hydrofluorocarbon forms an azeoptrope or azeotrope-like composition with methyl iodide. Fluorocarbons are defined herein as any carbon molecule having at least ones attached fluorine group. Hydrofluorocarbons can, be particularly useful in fumigant compositions of the present technology. The at least one fluorocarbon or hydrofluorocarbon can increase the overall volume of the fumigant compositions, facilitating application of the fumigant composition and increasing the time that given volume of methyl iodide is exposed to the article being fumigated. The at least one fluorocarbon or hydrofluorocarbon can further enable a more uniform and easily controlled-application of the fumigant composition. In addition, the at least one fluorocarbon or hydrofluorocarbon can serve as a non-toxic portion of the composition, reducing worker exposure to toxic materials.

Several different fluorocarbons and hydrofluorocarbons can be suitable for use in the fumigant compositions of the present technology. Examples of fluorocarbons that may be suitable nonexclusively include 1-chloro-3,3,3 trifluoropropene (HCFC-1233xd); 2,2-dichloro-1,1,1-trifluoroethane (HCFC-123); 1,1,2,2-tetrafluoroethyl methyl ether (HFE-245); cis-1,3,3,3-tetrafluoropropene (HFC-1234ze), (E)-1-chloro-3,3,3,-trifluoropropene (HFO-1233zd(E)), and (Z)-1-chloro-3,3,3,-trifluoropropene (HFO-1233zd(Z)). Examples of hydrofluorocarbons that may be suitable nonexclusively include 1,1,1,3,3-pentafluoropropane (HFC-245fa); 1,1,1,3,3-pentafluorobutane (HFC-365); 1,2-difluoroethane (HFC-152); 1,2,2,3,3-pentafluoropropane (245ca); 1,2,2-trifluoroethane (HFC-143), and mixtures thereof.

In some examples, the at least one fluorocarbon or hydrofluorocarbon preferably has a boiling point of from about 0° C. to about 50° C.

In some examples, the at least one fluorocarbon or hydrofluorocarbon preferably has an average Ozone Depletion Potential (ODP) of about 0.05 or less. The ozone depletion potential (ODP) of a chemical compound is the relative amount of degradation to the ozone layer it can cause, with trichlorofluoromethane (R-11) being fixed at an ODP of 1.0. Chlorodifluoromethane (R-22), for example, has an ODP of 0.05.

In some examples, the at least one fluorocarbon or hydrofluorocarbon preferably has a 100-year Global Warming Potential (GWP) of about 1,000 or less. Global warming potential (GWP) is a measure of how much a given mass of greenhouse gas is estimated to contribute to global warming. It is a relative scale which compares the gas in question to that of the same mass of carbon dioxide, whose GWP is 1 by definition. A GWP is calculated over a specific time interval and the value of this must be stated whenever a GWP is quoted. The most common time interval used today is 100 years.

The fumigant compositions preferably comprise effective amounts of methyl iodide and the at least one fluorocarbon or hydrofluorocarbon. The term “effective amounts” as used herein refers to the amount of each component which, upon combination with the other component or components results in the formation of an azeotropic or azeotrope-like composition. The methyl iodide is preferably present in, an amount from about 5 weight percent based on the total weight of the fumigant composition to about 70 weight percent based on the total weight of the fumigant composition, more preferably from about 15 weight percent based on the total weight of the fumigant composition to about 60 weight percent based on the total weight of the fumigant composition, and most preferably from about 25 weight percent based on the total weight of the fumigant composition to about 50 weight percent based on the total weight of the fumigant composition. The at least one fluorocarbon or hydrofluorocarbon is preferably present in the composition in an amount from about 30 weight percent based on the total weight of the fumigant composition to about 95 weight percent based on the total weight of the fumigant composition, more preferably from about 40 weight percent based on the total weight of the fumigant composition to about 85 weight percent based on the total weight of the fumigant composition, and most preferably from about 50 weight percent based on the total weight of the fumigant composition to about 75 weight percent based on the total weight of the fumigant composition.

In certain instances, the at least one selected fluorocarbon or hydrofluorocarbon can include 1,1,1,3,3-pentafluoropropane (HFC-245fa), 1,1,1,3,3-pentafluorobutane (HFC-365), cis-1,3,3,3-tetrafluoropropene (HFC-1234ze), 1-chloro-3,3,3,-trifluoropropene (HFO-1233zd(E)), or mixtures thereof. It has been found that methyl iodide and each of these selected hydrofluorocarbons form an azeotropic mixture that closely resembles several physical properties of methyl bromide, including as specific gravity and density. These selected hydrofluorocarbons result in a gaseous composition that serves as a drop-in replacement for methyl bromide, providing benefits if a methyl iodide fumigant while also utilizing existing methyl bromide equipment. Advantageously, these hydrofluorocarbons are also less toxic and less harmful to the atmosphere than methyl bromide.

For example, HFC-245fa, is a nonflammable and, non-toxic compound with an ozone depletion potential of zero, and when mixed with methyl iodide it forms an azeotrope that has a boiling point of about 12.0° C. to about 14.5° C. at atmospheric pressure depending on the composition of the blend, which is substantially below the boiling, point of either of the two components individually. In another example HFC-365 forms an azeotrope with methyl iodide that has a boiling; point of about 30° C. to about 26° C. at atmospheric pressure depending on the composition of the blend, which is also substantially below the boiling point of either of the two components individually. In a third example, the at least one selected fluorocarbon or hydrofluorocarbon can include a mixture of at least two compounds selected from the group consisting of HFC-245fa, HFC-365, HFC-1234ze, and HFO-1233zd(E). In one instance, the selected fluorocarbon or hydrofluorocarbon can include HFC-1233zd(E) and at least one other fluorocarbon or hydrofluorocarbon. In such instances, the HFO-1233zd(E) can be present in the composition in an amount from about 10 weight percent based on, the total weight of the fumigant composition to about 98.7 weight percent based on the total weight of the fumigant composition, including from about 35 weight percent based on the total weight of the fumigant composition to about 94 weight percent based on the total weight of the fumigant composition, or, from about 60 weight percent based on the total weight of the fumigant composition to about 88 weight percent based on the total weight of the fumigant composition. The at least one other fluorocarbon or hydrofluorocarbon can be present in the fumigant composition in an amount from about 1 weight percent based on the total weight of the fumigant composition to about 40 weight percent based on the total weight of the fumigant composition, including from about 5 weight percent based on the total weight of the fumigant composition to about 35 weight percent based on the total weight of the fumigant composition, or from about 10 weight percent based on the total weight of the fumigant composition to about 30 weight percent based on the total weight of the fumigant composition.

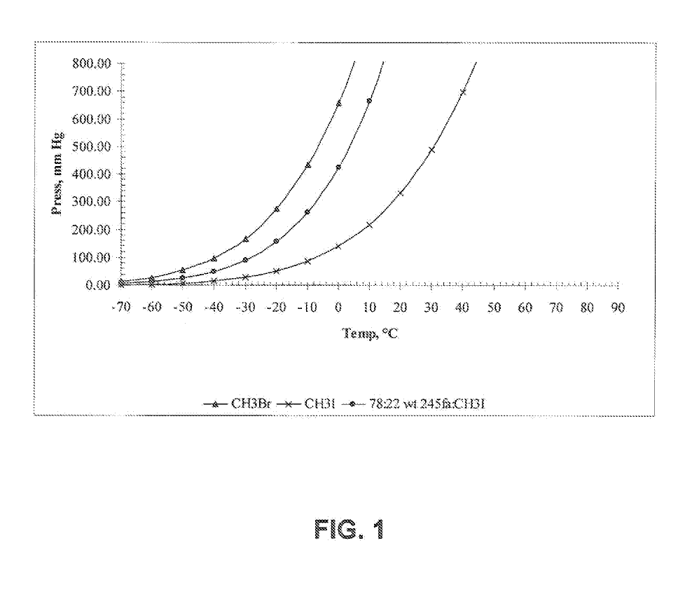

The fumigant compositions may be in the form, of binary azeotropes, which should be understood herein as consisting of, or consisting essentially of, an azeotropic or azeotrope-like composition of methyl iodide and the at least one fluorocarbon or hydrofluorocarbon for example, FIG. 1 which illustrates a vapor pressure versus temperature curve of a binary azeotrope of methyl iodide and HFC-245fa. As shown in FIG. 1, the composition is a gas at room temperature, indicating that it could be applied as a liquefied gas for fumigation in the same manner as methyl bromide. The presence of methyl iodide as the active fumigant in the blend provides the efficacy and spectrum of activity. The HFC-245fa is an inert component that lowers the boiling point of the blend and increases the volume of fumigant applied to a given area so that a more uniform and easily controlled application is accomplished. The HFC-245fa is a non-toxic fluorocarbon, and thus reduces worker exposure to toxic materials as compared to compositions comprising solely methyl bromide or methyl iodide.

In one example, where the fumigant composition consists of, or consists, essentially of, methyl iodide and HFC-245fa, the fumigant composition can include the HFC-245fa in an amount from about 40 weight percent based upon the total fumigant composition to about 90 weight percent based. Up on the total fumigant composition. In a second example, where the fumigant composition consists of, or consists essentially of, methyl iodide and HFC-365, the fumigant composition can include the HFC-365 in an amount from about 35 weight percent based upon the total fumigant composition to about 65 weight percent based upon the total fumigant composition. In a third example, where the fumigant composition consists of, or consists essentially of, methyl iodide and cis-HFC-1234ze, the fumigant composition can include the cis-HFC-1234ze in an amount from about 45 weight percent based upon the total fumigant composition to about 95 weight percent based upon the total fumigant composition. In a fourth example, where the fumigant composition consists of, or consists essentially of, methyl iodide and HFO-1233zd(E), the fumigant composition can include the HFO-1233zd(E) in an amount from about 50 weight percent based upon the total fumigant composition to about 99.7 weight percent based upon the total fumigant composition, from about 70 weight percent based upon the total fumigant composition to about 99 weight percent based upon the total fumigant composition, or from about 90 weight percent based upon the total fumigant composition to about 98 weight percent based, upon the total fumigant composition.

Fumigant compositions may optionally include additional components or additives. Suitable additives nonexclusively include chloropicrin, acrolein, 1,3-dichloropropene, dimethyl disulfide, furfural, and propylene oxide. The optional additive included in the fumigant composition can be present in an amount of from about 0 weight percent based on the total weight of the fumigant composition to about 40 weight percent based on the total weight of the fumigant composition, from about 0.5 weight percent based on the total weight of the fumigant composition to about 5 weight percent based on the total weight of the fumigant composition, or from about 1 weight percent based on the total weight of the fumigant composition to about 3 weight percent based on the total weight of the fumigant composition. Chloropicrin is one preferred additive. In one example, fumigant composition can comprise 33% methyl iodide, 33% of the at least one fluorocarbon or hydrofluorocarbon, and 33% chloropicrin.

To make the fumigant compositions, the methyl iodide, the at least one fluorocarbon or hydrofluorocarbon, and any optional additives, can be combined using any conventional means which results in a substantially homogeneous mixture of all components. When combined, the mixture forms an azeotropic or azeotrope-like composition.

The fumigant compositions are in the form of a gas at temperatures of about 30° C. or below, and in certain examples preferably at about 20° C. or below, such that they are in the form of a gas at room temperature and in a range of normal ambient temperatures. In a some examples, the fumigant compositions have a boiling point from about 8° C. to about 14.5° C., from about 8° C. to about 13.8° C., or from about 8° C. to about 12.7° C.

Additionally, the fumigant compositions can have a density of from about 1.5 g/cc to about 2.4 g/cc, from about 1.6 g/cc to about 2.0 g/cc, or from about 1.6 g/cc to about 1.8 g/cc.

The fumigant compositions can be used in a variety of applications, including pre-planting soil fumigation, fumigation of building structures, and product fumigation including post-harvest quarantine, pre-shipment fumigation and quarantine fumigation. Some examples of fumigation applications for the fumigant compositions nonexclusively include combating insects, termites, rodents, weeds; nematodes, and soil-borne diseases. Additional examples include fumigation of a harvested agricultural product or a food product. Such fumigation can be done in building structures such as, grain elevators, mills, ships, greenhouses, and other storage buildings.

In some applications; the fumigant compositions of the present technology can be used as a drop-in replacement for methyl bromide, and can thus be pumped through existing, fumigation pipes and systems that were originally designed for methyl bromide use. For example, fumigant compositions that, are in the form of a gas at temperatures of about 30° C. or below and have a density of from about 1.5 g/cc to about 2.4 g/cc as described above can be used in such applications. These fumigant compositions tend to greatly, reduce and even eliminate the problems of clogged tubing, pooled deposits of chemicals that are typically associated with attempting to use liquid methyl iodide, and can be easily purged from an existing methyl bromide system. In fact, methyl iodide's particular difficulty of missed bed application can be overcome because the fumigant compositions of the present technology, like methyl bromide, are present as a gas at ambient temperature and, move easily through application tubing of an existing methyl bromide system. Furthermore, the fumigant compositions described herein have a very similar environmental efficacy and spectrum of activity as methyl bromide, while also exhibiting a low potential for ozone degradation.

Processes for fumigating products can include providing a fumigant composition of the present technology, and applying the fumigant composition to a product to produce a fumigated, product in preferred examples, the product can be an agricultural product such as a harvested product or a food product. Agricultural products can include, but are not limited to, fruits, vegetables, plants; flowers, dried fruits, nuts, fresh root crops, cotton, tobacco, tea, cocoa, coffee beans, mate, kola, grains, dried fruits, cereals, oilseeds, pulses, spices, herbs, meats, and cheeses. Fruits include, for example, citrus fruits such as oranges, lemons, limes, and grapefruit. Plants include, for example, potted plants, cut plants, dried plants, dried leaves, seedlings, and saplings. Flowers, while being a subset of plants, should be understood to include, for example, flower bulbs, dried flowers, and cut flowers. Meats include, for example, cured meat and dried meat.

The step of applying the fumigant composition can include applying the fumigant at an ambient temperature, which is preferably a temperature from about 0° C. to about 50° C., more preferably from about 8° C. to about 35° C.

In one example, the fumigation process can also include a step of removing or substantially removing fumigant from the product after the fumigant has been applied. The step of removing, can be conducted in any suitable manner, including, for example, by treating the fumigated product with heat, forced air, or both heat and forced air. In some examples, the removing, step can be conducted for a time period from about 5 seconds to about 1 hour, preferably for from about 10 minutes to about 20 minutes. The process can also include recovering removed fumigant and disposing of the recovered fumigant. Disposing of the recovered fumigant can include, for example, recycling or burning.

The following non-limiting examples serve to illustrate the invention. It will be appreciated that variations in proportions and alternatives in elements of the components of the invention will be apparent to those skilled in the art and are within the scope of the present invention.

### Example 1

An ebulliometer consisting of vacuum jacketed tube with a condenser on top which is further equipped with a Quartz Thermometer was used to examine, the azeotropic or azeotrope-like properties exhibited by compositions of HFC-245fa and methyl iodide. About 22 g HFC-245fa was charged to the ebulliometer and then methyl iodide is added in small, measured increments. A temperature depression was observed when methyl iodide was added to HFC-245fa indicating a binary minimum boiling azeotrope was formed. The atmospheric pressure was measured to be 14.50 psia. For methyl iodide amounts from greater than about 0 weight percent based on the total composition to about 60 weight percent based on the total composition, the boiling point of the composition changed by about 3° C. or less. The compositions exhibit azeotropic or azeotrope-like properties over this range. For example, the binary mixtures shown below in Table 1 were studied and the boiling point of the compositions from 10 wt % CH₃I to about 60 wt % CH₃I changed by less than about 0.5° C.

TABLE 1

| Wt. % | Wt. % | Boiling Point: |
|---|---|---|
| CH₃I | HFC-245fa | Temp(° C.) |
| 0.00 | 100.00 | 14.83 |
| 0.54 | 99.46 | 14.60 |
| 1.61 | 98.39 | 14.19 |
| 4.69 | 95.31 | 13.55 |
| 9.40 | 90.60 | 12.94 |
| 14.48 | 85.52 | 12.62 |
| 19.02 | 80.98 | 12.50 |
| 23.10 | 76.90 | 12.46 |
| 26.39 | 71.21 | 12.42 |
| 30.14 | 69.86 | 12.40 |
| 33.20 | 66.80 | 12.43 |
| 36.01 | 63.99 | 12.45 |
| 38.99 | 61.01 | 12.47 |
| 41.71 | 58.29 | 12.48 |
| 44.54 | 55.46 | 12.50 |
| 47.10 | 52.90 | 12.51 |
| 49.44 | 50.56 | 12.53 |
| 51.58 | 48.42 | 12.53 |
| 53.54 | 46.46 | 12.55 |
| 55.57 | 44.43 | 12.55 |
| 57.43 | 42.57 | 12.56 |

### Example 2

An ebulliometer consisting of vacuum jacketed tube with a condenser on top similar to the one in Example 1 was used to examine the azeotropic or azeotrope-like properties exhibited by compositions of HFC-365 and methyl iodide. About 10 g HFC-365 was charged to the ebulliometer and then methyl iodide was added in small, measured increments. A temperature depression was observed when methyl iodide was added to HFC-365, with a minimum boiling temperature below the boiling point of pure methyl iodide and pure. HFC-365, indicating, a binary minimum boiling azeotrope was formed. The atmospheric pressure was measured to be 14.29 psia. For HFC-365 amounts from greater than about 80 weight percent based on the total composition to about 45 weight percent based on the total composition, the boiling point of the composition changed by about 2° C. or less. The compositions exhibit azeotropic or azeotrope-like properties over this range. For example, the binary mixtures shown in Table 2 were studied, and the boiling point of the compositions having a methyl iodide amount from about 35 weight percent based on the total composition to about 65 weight percent based on the total composition changed by less than about 0.5° C.

TABLE 2

| Wt. % | Wt. % | Boiling Point |
|---|---|---|
| CH₃I | HFC-365 | Temp(° C.) |
| 0.0 | 100.0 | 39.2 |
| 0.5 | 99.5 | 39.2 |
| 1.1 | 98.9 | 39.2 |
| 1.6 | 98.4 | 39.1 |
| 2.1 | 97.9 | 39.0 |
| 2.6 | 97.4 | 38.4 |
| 3.2 | 96.8 | 37.5 |
| 3.7 | 96.3 | 36.8 |
| 4.2 | 95.8 | 36.2 |
| 4.7 | 95.3 | 35.9 |
| 5.1 | 94.9 | 35.6 |
| 5.6 | 94.4 | 35.5 |
| 6.1 | 93.9 | 35.4 |
| 6.6 | 93.4 | 35.0 |
| 7.1 | 92.9 | 35.1 |
| 7.5 | 92.5 | 35.4 |
| 8.0 | 92.0 | 35.1 |
| 8.4 | 91.6 | 34.8 |
| 8.9 | 91.1 | 34.5 |
| 9.3 | 90.7 | 34.2 |
| 9.8 | 90.2 | 34.1 |
| 10.2 | 89.8 | 32.8 |
| 10.7 | 89.3 | 32.7 |
| 11.1 | 88.9 | 32.6 |
| 11.5 | 88.5 | 32.5 |
| 11.9 | 88.1 | 32.4 |
| 12.4 | 87.6 | 32.4 |
| 12.8 | 87.2 | 32.3 |
| 13.6 | 86.4 | 32.2 |
| 14.4 | 85.6 | 32.0 |
| 15.2 | 84.8 | 32.0 |
| 16.0 | 84.0 | 31.8 |
| 16.7 | 83.3 | 31.6 |
| 17.5 | 82.5 | 31.4 |
| 18.9 | 81.1 | 31.0 |
| 20.3 | 79.7 | 30.9 |
| 21.7 | 78.3 | 30.6 |
| 23.0 | 77.0 | 30.5 |
| 24.3 | 75.7 | 30.3 |
| 25.5 | 74.5 | 30.3 |
| 26.7 | 73.3 | 30.3 |
| 27.8 | 72.2 | 30.2 |
| 28.9 | 71.1 | 30.1 |
| 30.0 | 70.0 | 29.9 |
| 31.1 | 68.9 | 29.9 |
| 32.1 | 67.9 | 29.8 |
| 33.1 | 66.9 | 29.7 |
| 34.0 | 66.0 | 29.6 |
| 35.0 | 65.0 | 29.5 |
| 35.9 | 64.1 | 29.5 |
| 36.7 | 63.3 | 29.5 |
| 37.6 | 62.4 | 29.5 |
| 38.4 | 61.6 | 29.5 |
| 39.2 | 60.8 | 29.5 |
| 40.0 | 60.0 | 29.5 |
| 40.8 | 59.2 | 29.5 |
| 41.6 | 58.4 | 29.5 |
| 42.3 | 57.7 | 29.4 |
| 43.0 | 57.0 | 29.4 |
| 43.7 | 56.3 | 29.4 |
| 44.4 | 55.6 | 29.4 |
| 45.0 | 55.0 | 29.4 |
| 45.7 | 54.3 | 29.3 |
| 46.3 | 53.7 | 29.3 |
| 46.9 | 53.1 | 29.2 |
| 47.5 | 52.5 | 29.2 |
| 48.1 | 51.9 | 29.2 |
| 48.7 | 51.3 | 29.2 |
| 49.3 | 50.7 | 29.2 |
| 49.8 | 50.2 | 29.2 |
| 50.4 | 49.6 | 29.2 |
| 50.9 | 49.1 | 29.2 |
| 51.4 | 48.6 | 29.2 |
| 51.9 | 48.1 | 29.2 |
| 52.4 | 47.6 | 29.2 |
| 52.9 | 47.1 | 29.2 |
| 53.4 | 46.6 | 29.1 |
| 53.9 | 46.1 | 29.1 |
| 54.3 | 45.7 | 29.1 |
| 54.8 | 45.2 | 29.1 |
| 55.2 | 44.8 | 29.1 |
| 55.6 | 44.4 | 29.1 |
| 56.1 | 43.9 | 29.1 |
| 56.5 | 43.5 | 29.0 |
| 56.9 | 43.1 | 29.0 |
| 57.3 | 42.7 | 29.0 |
| 57.7 | 42.3 | 29.0 |
| 58.1 | 41.9 | 29.0 |
| 58.4 | 41.6 | 29.0 |
| 58.8 | 41.2 | 29.0 |
| 59.2 | 40.8 | 29.0 |
| 59.5 | 40.3 | 29.0 |
| 59.9 | 40.1 | 29.0 |
| 60.2 | 39.8 | 29.0 |
| 60.6 | 39.4 | 29.0 |
| 60.9 | 39.1 | 29.0 |
| 61.2 | 38.8 | 29.0 |
| 61.6 | 38.4 | 29.0 |
| 61.9 | 38.1 | 29.0 |
| 62.2 | 37.8 | 29.0 |
| 62.5 | 37.5 | 29.0 |
| 62.8 | 37.2 | 29.0 |
| 63.1 | 36.9 | 29.0 |
| 63.4 | 36.6 | 29.0 |
| 63.7 | 36.3 | 29.0 |
| 64.0 | 36.0 | 29.0 |
| 64.2 | 35.8 | 29.0 |
| 64.5 | 35.5 | 29.0 |
| 64.8 | 35.2 | 29.0 |

### Example 3

An ebulliometer consisting of vacuum jacketed tube with a condenser on top which is further equipped with a Quartz Thermometer was used to examine the azeotropic or azeotrope-like properties exhibited by compositions of cis-HFC-1234ze and methyl iodide. About 19.5 g of cis-HFC-1234ze was charged to the ebulliometer. The cis-HFC-1234ze contained approximately 9% HFC-245fa as an impurity. Then methyl iodide was added in small, measured increments. A temperature depression was observed when methyl iodide was added to the cis-HFC-1234ze, indicating that a binary minimum boiling azeotrope was formed. The atmospheric pressure was measured to be 14.42 psia. For amounts of methyl iodide from greater than about 0 weight percent based on the total, weight of the composition to about 55 weight percent based on the total weight of the composition, the boiling point of the composition changed by about 1° C. or less. The compositions exhibit azeotropic and/or azeotrope-like properties over this range. For example, the binary mixtures shown below in Table 3 were studied, and the boiling point of the compositions having methyl iodide in an amount from about 5′ weight percent based on the total weight of the composition to about 55 weight percent based on the total weight of the composition changed by less than about 0.5° C.

TABLE 3

| Wt. % | Wt. % | Boiling Point |
|---|---|---|
| CH₃I | cis-HFC-1234ze | Temp(° C.) |
| 0.00 | 100.00 | 9.68 |
| 0.61 | 99.39 | 9.61 |
| 1.82 | 98.18 | 9.46 |
| 5.27 | 94.73 | 9.20 |
| 8.48 | 91.52 | 9.03 |
| 12.44 | 87.56 | 8.81 |
| 16.07 | 83.93 | 8.81 |
| 19.41 | 80.59 | 8.75 |
| 23.23 | 76.77 | 8.74 |
| 26.71 | 73.29 | 8.73 |
| 29.88 | 70.12 | 8.78 |
| 32.79 | 67.21 | 8.88 |
| 36.98 | 63.02 | 8.90 |
| 40.67 | 59.33 | 8.94 |
| 43.96 | 56.04 | 8.98 |
| 46.90 | 53.10 | 9.11 |
| 49.55 | 50.45 | 9.14 |
| 51.94 | 48.06 | 9.16 |
| 54.12 | 45.88 | 9.17 |

### Example 4

An ebulliometer composed of a vacuum jacketed tube with a condenser on top which was further equipped with a Quartz Thermometer was used to examine the azeotropic or azeotrope-like properties exhibited by composition of HFO-1233zd(E) and methyl iodide. About 20 g of HFO-1233zd(E) was charged into the ebulliometer and then methyl iodide was added in small, measured increments, at an atmospheric pressure of 14.4 psia. A temperature depression was observed when methyl iodide was added to HFO-1233zd (E), indicating a binary minimum boiling azeotrope had been formed. For methyl iodide in amounts from greater than about 0 weight percent based on the total composition to about 30 weight percent based on the total composition, the boiling point of the composition changed less than about 0.5° C., with a minimum in the boiling point curve occurring at compositions having methyl iodide in an amount from about 2 weight percent based on the total composition to about 6 weight, percent based on the total composition. Thus the compositions exhibited azeotrope or azeotrope-like properties over this range.

Results are set forth below in Table 4.

TABLE 4

| Wt. % | HFO- | Boiling Point |
|---|---|---|
| CH₃I | 1233zd(E) | Temp(° C.) |
| 0.00 | 100 | 17.75 |
| 0.56 | 99.90 | 17.75 |
| 1.67 | 98.78 | 17.74 |
| 3.81 | 96.63 | 17.74 |
| 5.86 | 94.57 | 17.76 |
| 9.72 | 90.70 | 17.81 |
| 14.11 | 86.29 | 17.90 |
| 18.09 | 82.29 | 17.99 |
| 23.75 | 76.60 | 18.12 |
| 28.68 | 71.65 | 18.20 |

the HFO-1233zd(E) is preferably present in the composition in an amount from about 50 to about, 99.7 weight percent of the composition, more preferably from about 70 to about 99 weight percent of the composition, and most preferably from about 90 to about 98 weight percent of the composition.

### Example 5

### Fumigation

Methyl iodide and HFC-245fa were combined in various proportions as listed below in Table 5 to form fumigant compositions. The fumigant compositions were each introduced into a 17 liter (0.6 cu ft) vacuum oven containing of a 50% load by volume comprised of lemons in cheesecloth bags in order to simulate bulk fumigation. The fumigation process included holding the vacuum oven for 2 hours at room temperature under normal atmospheric pressure after the fumigant composition had been introduced. Following fumigation, the vacuum oven was aerated with forced air for 15 minutes. After the treatments, the lemons were held in a refrigerator at a temperature of 5° C. for a total period of 6 weeks and periodic evaluation of the quality/phytotoxicity was undertaken as described below.

### Fruit Quality/Phytotoxicity Evaluation

The lemons were evaluated after the second, fourth and sixth week of storage at 5° C. for any rind pitting or staining that developed after fumigation. Each, fruit was visually rated using a scale of:
Healthy—sound quality commercial, blemish-free;
Slight—very mild pitting or staining, with injury covering, 1-5% of the flavedo (pigmented) surface area but would not affect marketability of the fruit;
Moderate—injury more pronounced and larger lesions covering 25% of the flavedo, these fruit may still be saleable but less attractive; or
Severe—fruit with darkened areas and staining of the flavedo exhibiting a scalded appearance over >25% of the flavedo area and making the fruit unmarketable.
   The results of the study are set forth below in Table 5.

TABLE 5

| MeI/HFC-245fa | 2^{nd} | 4^{th} | 6^{th} |
|---|---|---|---|
| weight % ratio | Week | Week | Week |
| 0/100 | Healthy | Healthy | Healthy |
| 25/75 | Healthy | Healthy | Slight |
| 50/50 | Healthy | Healthy | Moderate |
| 75/25 | Healthy | Slight | Severe |
| 100/0 | Healthy | Slight | Severe |
| 0/0 (Control) | Healthy | Healthy | Healthy |

The efficacy of methyl iodide for post-harvest pest disinfestation has been recognized, but the methyl iodide induced injury causing fruit quality reduction diminishes its usefulness. It has been found that a fluorocarbon azeotrope with methyl iodide is a good fumigant for postharvest fresh commodity disinfestation without causing injury to the fruit. When lemons were treated with the methyl iodide/HFC-245fa azeotrope to control California red scale (Aonidiella aurantii), the fruit fumigated with blends from pure, HFC-245fa to a 50:50 blend of methyl iodide and HFC-245fa show no injury to the fruit even after four weeks storage at 5° C. Fruit fumigated with blends of greater than 50% methyl iodide show slight blemishing after four weeks of storage. The lower boiling point of the azeotrope, as compared to methyl iodide, allows the methyl iodide component to reside on the fruit long enough to be efficacious but not long enough to allow the unreacted fumigant to cause injury to the fruit. The methyl iodide-azeotrope boils away before it can be phytotoxic. The azeotrope, of methyl iodide with HFC-245fa is an excellent drop-in replacement for methyl bromide. The azeotrope is a good methyl bromide alternative for fumigation of perishable items including fruits, vegetables, ornamental plants, flower bulbs, cut flowers, dried fruits and nuts and fresh root crops. Quarantine and pre-shipment, fumigations will be easily accomplished because; of the low boiling point of the azeotrope. It uses the same application techniques, has essentially the same environmental impact efficacy and spectrum of activity as methyl bromide and a low potential for degrading the earth's ozone layers.

### Example 6

### Fumigation

Methyl iodide and 1,1,1,3,3-pentafluorobutane (HFC-365) are combined in various proportions as defined by their azeotrope and tested as in Example 5.

### Example 7

### Fumigation

Methyl iodide and 1,3,3,3-tetrafluoropropene (cis-HFC-1234ze) are combined in various proportions as defined by their azeotrope and tested as in Example 5.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of fumigating a perishable product, the method comprising the steps of:
providing a fumigant composition that is a gas at temperatures of about 30° C. or below, the fumigant composition comprising an azeotropic or azeotrope-like composition that include a mixture of methyl iodide and at least one fluorocarbon or hydrofluorocarbon; and
applying the fumigant composition as a gas to a perishable product to produce a fumigated product.

2. The method of claim 1, wherein the perishable product is selected from the group consisting of fruits, vegetables, plants, flowers, dried fruits, nuts, fresh root crops, cotton, tobacco, tea, cocoa, coffee beans, mate, kola, grains, dried fruits, cereals, oilseeds, pulses, spices, herbs, meats, and cheeses.

3. The method of claim 1, further comprising the step of substantially removing the fumigant composition from the fumigated product.

4. The method of claim 3, wherein the step of removing comprises treating the fumigated product with heat, forced air, or both heat and forced air.

5. The method of claim 4, wherein the step of removing is conducted for a time period from about 5 seconds to about 1 hour.

6. The method of claim 5, wherein the time period is from about 10 minutes to about 20 minutes.

7. The method of claim 3, wherein the method further comprises the step of recovering fumigant that has been removed from the fumigated product.

8. The method of claim 1, wherein the azeotropic or azeotrope-like composition comprises at least one fluorocarbon or hydrofluorocarbon selected from the group consisting of 1-chloro-3,3,3 trifluoropropene (HCFC-1233xd); 2,2-dichloro-1,1,1-trifluoroethane (HCFC-123); 1,1,2,2-tetrafluoroethyl methyl ether (HFE-245); cis-1,3,3,3-tetrafluoropropene (HFC-1234ze), (E)-1-chloro-3,3,3,-trifluoropropene (HFO-1233zd(E)), and (Z)-1-chloro-3,3,3,-trifluoropropene (HFO-1233zd(Z)). Examples of hydrofluorocarbons that may be suitable nonexclusively include 1,1,1,3,3-pentafluoropropane (HFC-245fa); 1,1,1,3,3-pentafluorobutane (HFC-365); 1,2-difluoroethane (HFC-152); 1,2,2,3,3-pentafluoropropane (245ca); 1,2,2-trifluoroethane (HFC-143), and mixtures thereof.

9. The method of claim 8 wherein the azeotropic or azeotrope-like composition comprises at least one fluorocarbon or hydrofluorocarbon selected from the group consisting of 1,1,1,3,3-pentafluoropropane (HFC-245fa), 1,1,1,3,3-pentafluorobutane (HFC-365), cis-1,3,3,3-tetrafluoropropene (HFC-1234ze), 1-chloro-3,3,3,-trifluoropropene (HFO-1233zd(E)), and mixtures thereof.

10. The method of claim 1, wherein the methyl iodide is present in an amount from about 5 weight percent based on the total weight of the fumigant composition to about 70 weight percent based on the total weight of the fumigant composition.

11. The method of claim 1, wherein the fumigant composition further comprises chloropicrin.

12. The method of claim 1, wherein the fumigant composition comprises an azeotropic or azeotrope-like composition consisting essentially of methyl iodide and at least one fluorocarbon or hydrofluorocarbon is selected from the group consisting of 1,1,1,3,3-pentafluoropropane (HFC-245fa) in an amount from about 46 weight percent based on the weight of the fumigant composition to about 90 weight percent based on the weight of the fumigant composition, 1,1,1,3,3-pentafluorobutane (HFC-365) in an amount from about 35 weight percent based on the weight of the fumigant composition to about 65 weight percent based on the weight of the fumigant composition, cis-1,3,3,3-tetrafluoropropene (HFC-1234ze) in an amount from about 45 weight, percent based on the weight of the fumigant composition to about 95 weight percent limed on the weight of the fumigant composition, and 1-chloro-3,3,3,-trifluoropropene (HFO-1233zd(E)) in an amount from about 50 Weight percent based on the weight of the fumigant composition to about 99.7 weight percent based on the weight of the fumigant composition.

13. The method, of claim 1, wherein the step of applying is conducted at a temperature from about 0° C. to about 50° C.

14. A method of fumigating a perishable product, the method comprising the steps of:
providing a fumigant composition that has a density of from about 1.5 g/cc to about 2.4 g/cc the fumigant composition comprising an azeotropic or azeotrope-like composition that includes a mixture of methyl iodide and at least one fluorocarbon or hydrofluorocarbon, wherein the at least one fluorocarbon or hydrofluorocarbon has an average Ozone Depletion Potential of about 0.05 or less and a 100-year Global Warming Potential of about 1,000 or less; and,
applying the fumigant composition as a gas at a temperature from about 0° C. to about 50° C. to a perishable product to produce a fumigated product.

15. The method of claim 14, wherein the perishable product is selected from the group consisting of fruits, vegetables, plants, flowers, dried fruits, nuts, fresh root crops, cotton, tobacco, tea, cocoa, coffee beans, mate, kola, grains, dried fruits, cereals, oilseeds, pulses, spices, herbs, meats, and cheeses.

16. The method of claim 14, further comprising the step of substantially removing the fumigant composition from the fumigated product.

17. The method of claim 16, wherein the step of removing comprises treating the fumigated product with heat, forced air, or both heat and forced air.

18. The method of claim 17, wherein the step of removing is conducted for a time period from about 5 seconds to about 1 hour.

19. The method of claim 16, wherein the method further comprises the step of recovering fumigant that has been removed, from the fumigated product.

20. The method of claim 14, wherein the azeotropic or azeotrope-like composition comprises at least one fluorocarbon or hydrofluorocarbon selected from the group consisting of 1-chloro-3,3,3 trifluoropropene (HCFC-1233xd); 2,2-dichloro-1,1,1-trifluoroethane (HCFC-123); 1,1,2,2-tetrafluoroethyl methyl ether (HFE-245); cis-1,3,3,3-tetrafluoropropene (HFC-1234ze), (E)-1-chloro-3,3,3,-trifluoropropene (HFO-1233 zd(E)), and (Z)-1-chloro-3,3,3,-trifluoropropene (HFO-1233zd(Z)). Examples of hydrofluorocarbons that may be suitable nonexclusively include 1,1,1,3,3-pentafluoropropane (HFC-245fa); 1,1,1,3,3-pentafluorobutane (HFC-365); 1,2-difluoroethane (HFC-152); 1,2,2,3,3-pentafluoropropane (245ca); 1,2,2-trifluoroethane (HFC-143), and mixtures thereof.
